(19) United States
(12) Patent Application Publication
(10) Pub. No.: US 2007/0061129 A1
(43) Pub. Date: Mar. 15, 2007

(54) Localization of embedded devices using browser-based interfaces

(76) Inventor: Lionel Philippe Barreiro, Annoeullin (FR)

Correspondence Address: MACPHERSON KWOK CHEN & HEID LLP, 2033 GATEWAY PLACE, SUITE 400, SAN JOSE, CA, 95110, US

(21) Appl. No.: 11/227,331

(22) Filed: Sep. 14, 2005

(51) Int. Cl. G06F 17/27

(52) U.S. Cl. 704/9

(57) ABSTRACT

Systems and methods for interfacing with a management console for an embedded system are provided. The management console is presented to a browser application in a client device using a markup language, such as HTML. HTML data transmitted to the browser application is filtered before being displayed to the user. If the filter detects that the HTML data corresponds to the management console of a supported device, the filter will translate the text contained in the HTML data into a default language for that browser application. Thus, multilingual capabilities may be provided to an embedded system containing firmware programmed to display a management console in a single language.

### BACKGROUND

With the proliferation of networking gateway devices, particularly for home and small office/home office (SOHO) environments, it has become important to enable administrators to easily configure and manage these gateway devices. One way in which the ease of management has been improved has been by providing users with a management console interface using HTML (HyperText Markup Language). Thus, an administrator may utilize a conventional HTTP-based (HyperText Transfer Protocol) web browser application to access a management console web page hosted by a web server embedded in the firmware of the gateway device. An exemplary HTML-based management console interface 100 for a router is shown in FIG. 1.

As can be seen in FIG. 1, the management console interface 100 provides a user-friendly English language interface for guiding a user through the configuration of various settings for the router. However, in order to market the router in foreign countries, it is important to localize the device by providing a management console interface in the native language of the user.

A conventional method of localizing the management console is by manually translating and rewriting the HTML code for each target country. A problem with this solution is that it requires both a translator for translating the text into the foreign language, and a programmer to rewrite the HTML code using the translated text. Because the HTML code for the management console is part of the router's firmware, each localized router must then have its own version of the firmware in order to support the various languages. This requires that each version of the firmware be tested to ensure that the translation of the text in the HTML code did not introduce any bugs into the code. In addition, it requires that the router manufacturer support multiple versions of the firmware for each device.

Accordingly, it would be desirable to provide an improved method of providing multilingual support for embedded devices having HTML interfaces.

### DESCRIPTION OF THE DRAWINGS

FIG. 1 shows a management console interface for a router.

FIG. 2 is a block diagram of a system for managing an embedded system, in accordance with embodiments of the present invention.

FIG. 3 is flowchart of a method of interfacing with an embedded system using HTML, in accordance with embodiments of the present invention.

FIG. 4 is an exemplary process flow for a management session, in accordance with embodiments of the present invention.

FIG. 5 shows a portion of an exemplary translation file, in accordance with embodiments of the present invention.

FIG. 6 shows an exemplary localized management console interface translated from the management console interface of FIG. 1, in accordance with embodiments of the present invention.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

In accordance with embodiments of the present invention, a computer utilizes a web browser application to access a management console for an embedded system, such as a router or other gateway device. The management console is presented to the browser application using a markup language, such as HTML. HTML data transmitted to the browser application is filtered before being displayed to the user. If the filter detects that the HTML data corresponds to the management console of a supported device, the filter will translate the text contained in the HTML data into a default language for that browser application. Thus, multilingual capabilities may be provided to an embedded system containing firmware programmed to display a management console in a single language. The management console to be displayed by the browser may be automatically translated into a default language based on country settings of the operating system of the user's computer.

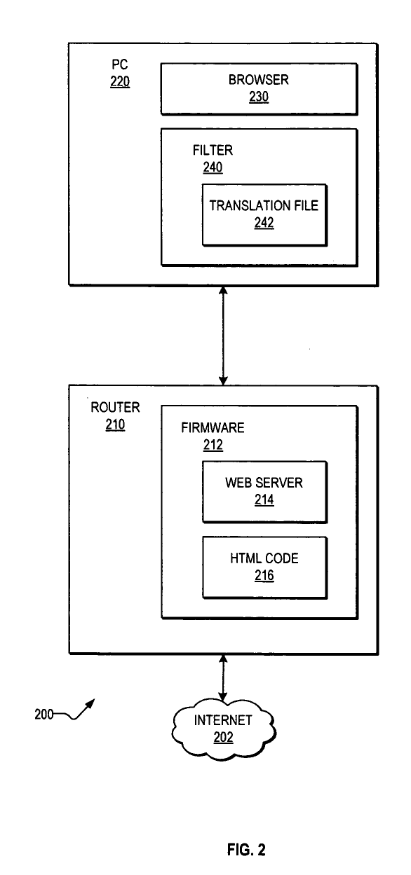

FIG. 2 is a block diagram of a system 200 for managing an embedded system, in accordance with embodiments of the present invention. An embedded system is a special-purpose computer system which has specific requirements and performs pre-defined tasks, unlike a general-purpose personal computer. Firmware is software that is stored in ROM memory (e.g., EEPROM, flash EEPROM, etc.) of the embedded system for controlling the operation of the device, and is executed using a microprocessor or a microcontroller.

In this embodiment, the embedded device comprises a gateway device which couples a client device to the Internet 202. A gateway device is a device that connects LANs or segments of LANs, such as a repeater, hub, bridge, router, or switch. These gateway devices may operate in one or more of the physical, data link, and network layers of the network model. In the illustrated embodiment, the gateway device comprises a router 210.

In this embodiment, the client device comprises a personal computer (PC) 220. The PC 220 may comprise multiple components not shown in FIG. 2, such as a processor, memory, mass storage device, display, and user input device, as would be understood by one of ordinary skill in the art. The PC 220 further comprises a web browser application 230, such as Microsoft Internet Explorer, Netscape Navigator, or Mozilla Firefox, which can use the HTTP protocol to retrieve and display text and graphics from web pages written using a markup language, such as HTML. In other embodiments, the client device may comprise other types of computing devices capable of displaying markup language data, such as a web-enabled cellular phone or a PDA (personal digital assistant).

A markup language is a coding system that combines content (e.g., text and graphics) and additional information about the content. The additional information, such as, e.g., information regarding the structure, presentation, and semantics of the content, is expressed using markup codes which can be intermingled with the content. The most commonly used markup language is HTML (Hypertext Markup Language), one of the foundations of the World Wide Web. Other types of markup languages are based on metalanguages such as Extensible Markup Language (XML) and Standard Generalized Markup Language (SGML), and include Extensible HyperText Markup Language (XHTML) and Dynamic HTML (DHTML). In other embodiments, other types of markup languages may be used.

The router 210 comprises firmware 212, which contains the code for controlling the operation of the router 210. Included in the firmware is code for operating a web server 214 and the markup language code (shown as HTML code 216). The web server 214 utilizes the HTML code 216 to provide a management console web page to the browser application 230 of the PC 220.

A filter 240 is provided in the PC 220 for filtering data, such as markup language data, retrieved by the browser application 230. The filter 240 may be implemented, e.g., using asynchronous pluggable protocols. Applications such as browser applications can use pluggable protocol handlers to filter data for a designated MIME (Multipurpose Internet Mail Extensions) type. Any data retrieved by the browser application 230 that has a MIME type matching the designated MIME type will call the MIME filter 240. The MIME filter 240 will filter the data stream and pass the filtered data stream to the browser application 230 to be displayed for the user. In the illustrated embodiment, the designated MIME type to be filtered by the MIME filter 240 is text/html, which is the type of data typically used for Web page content. The MIME filter 240 may be implemented using a permanent MIME filter installed as a DLL (Dynamic Link Library) file in the PC 220. This permanent MIME filter 240 is active in all running instances of the browser application. In other embodiments, the filter may be implemented using other mechanisms for processing a data stream prior to display by the browser application.

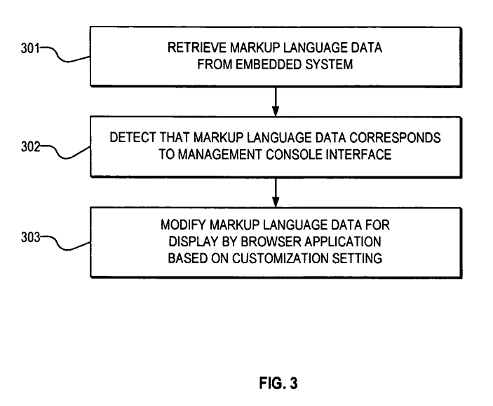

FIG. 3 is flowchart of a method of interfacing with an embedded system using a browser-based interface. In step 301, markup language data (e.g., HTML data) is retrieved from an embedded system, such as a router or other gateway device. In step 302, the filter detects that the retrieved markup language data corresponds to a management console interface for the embedded system. In step 303, the markup language data is modified for display by a browser application based on a customization setting.

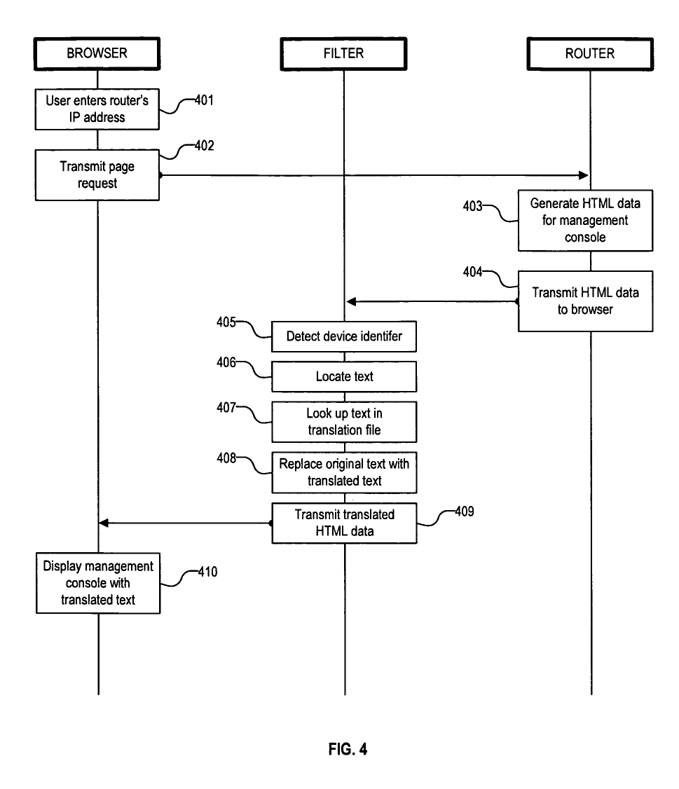

FIG. 4 is an exemplary process flow for a management session with reference to the system shown in FIG. 2, in accordance with embodiments of the present invention. In step 401, when a user at the PC 220 wishes to access the HTML-based management console for the router 210, the uses launches the browser application and directs the browser to the router's predetermined IP address. For example, the Wireless-G Access Point Model No. WAP54G v2 by Linksys uses the default IP address of 192.168.1.245.

In step 402, the page request for the router's IP address is transmitted to the router 210. When the router 210 receives the page request for this IP address, the router 210 in step 403 uses the web server 214 and the stored HTML code 216 to generate HTML data for the management console interface 100. In step 404, the router 210 transmits this HTML data to the PC 220.

After the HTML data is transmitted to the PC 220, the filter 240 intercepts the HTML data before the management console interface can be displayed by the browser application 230. When the user uses the browser application 230 to retrieve web pages from the Internet 202, the filter 240 allows all of the HTML data from the Internet 202 to pass through unmodified. However, in step 405, the filter 240 detects a device identifier in the HTML data that identifies the HTML data as corresponding to a management console interface, rather than HTML data from the Internet 202. This detection can occur in a variety of ways. In one embodiment, the router firmware 212 is configured to insert a keyword in the HTML page title, such as:
<HTML><HEAD><TITLE>WRT54G_V2 index</TITLE>

The “WRT54G_V2” keyword in the predetermined location indicates to the filter 240 that the HTML data corresponds to the management console interface for the Linksys Model No. WRT54G, version 2, Wireless-G Router. A different keyword may be used to uniquely identify each router model supported by the translation function provided by the filter 240. This facilitates the customized localization of different firmware versions for multiple types of devices. Alternatively, all of the routers supported by the translation function may include the same device identifier.

In step 406, the data to be modified is located in the received HTML data. The locating of the data for modification may be performed in a variety of ways. In the present example, the modification to be performed by the filter comprises a translation of the text from a first language (e.g., English) to a second language (e.g., French). Accordingly, the filter 240 will analyze all of the text in the HTML data to identify text strings that are to be displayed by the browser 230. This text may include, e.g., all text identified by the <TITLE>, <HEAD>, and <BODY> HTML tags.

In step 407, these text strings are located in a translation file 242, which provides translated versions of all of the text strings that may be located in the HTML data from the router 210. The translation file 242 may be provided in a variety of ways. For example, the translation file 242 may comprise a table or tab-delimitated text file, with each row in the table or text file corresponding to a single text string to be translated. Each column of the table or text file may include a translation of the text string into a unique language. The text string may comprise a single word or phrase.

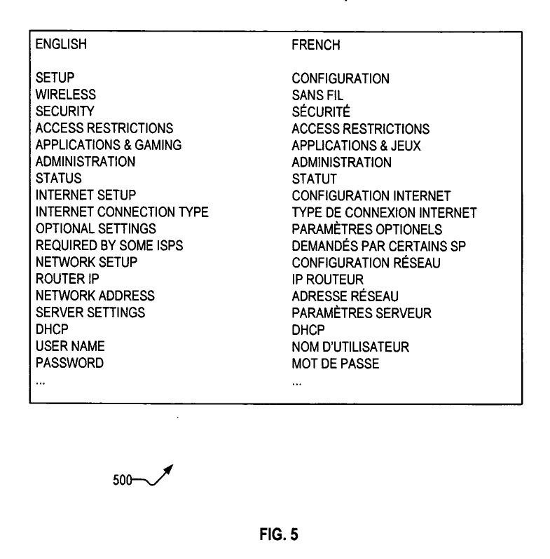

FIG. 5 shows a portion of an exemplary translation file 500. The first column includes text strings in the English language, and the second column includes the corresponding text string in French. In other embodiments, the translation file 500 may include additional columns for each supported language. Thus, if it is desired to add a localized version of the management console interface for China, a new column containing a Chinese translation of each text string can be added. Because the translation file 500 may be provided as a simple text file or table, the addition of a new column does not require reprogramming of the router's firmware or other software. In other embodiments, the translation file may be provided in different formats, such as, e.g., XML.

The determination of which language to use for the management console interface may be performed in a variety of ways. For example, the filter 240 may check the country settings of the operating system of the PC 220 and consult a language table to determine what language is appropriate for the identified country. The HTML data is then automatically translated to that language. In other embodiments, the user may be queried during an initial setup process to select a desired language for the management console interface.

As can be seen in the translation file 500, some English terms, such as “administration” and “DHCP” are identical to the corresponding French terms. Thus, the translation does not result in any change in the text string. In some embodiments, these identical terms may be omitted from the translation table 500, and the filter 240 may be configured to default to the original text string when no translated text string can be located in the translation file 500.

In some embodiments, a separate translation file may be provided for each unique firmware version of each supported device. Each time a new firmware version is released, a new translation file is generated for providing the translations of all of the text strings used by the management console interface for that firmware version. In other embodiments, a single translation file may be used for all or a set supported devices. This single translation file includes the translations for the text strings used by the management console interfaces for all firmware versions of all supported devices. The translation file as well as the DLL for the filter module may be installed on the user's PC 220 during an initial setup process.

In step 408, the original text string in the HTML data is replaced with the translated text string obtained from the translation file. The HTML code that defines the layout and design of the management console interface may be left unaltered, while only the text to be displayed by the browser is replaced. Thus, the management console interface may retain the same general appearance, while being localized for the language of the user.

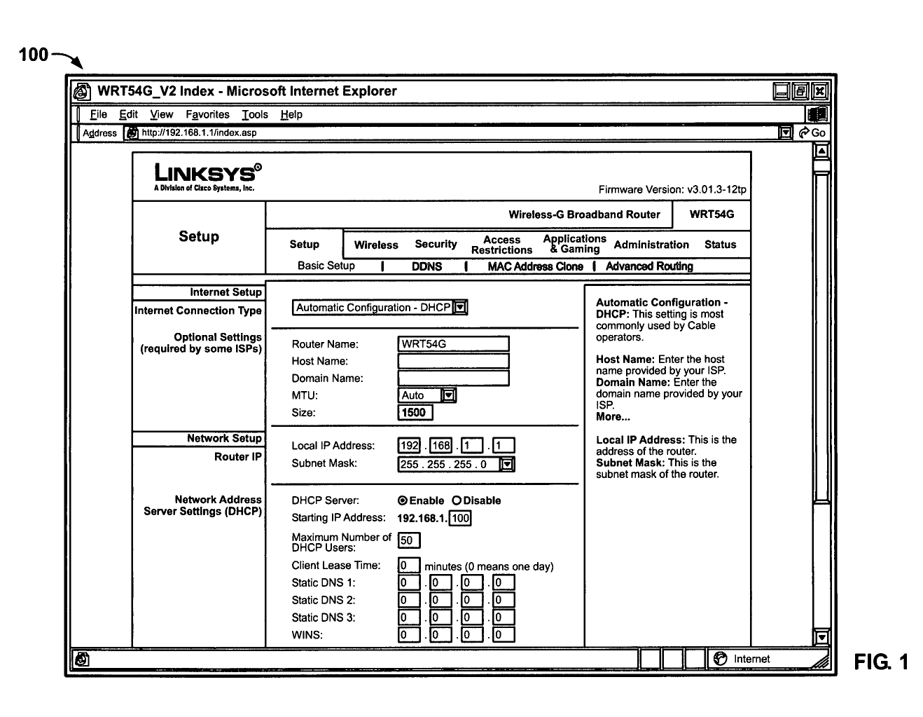

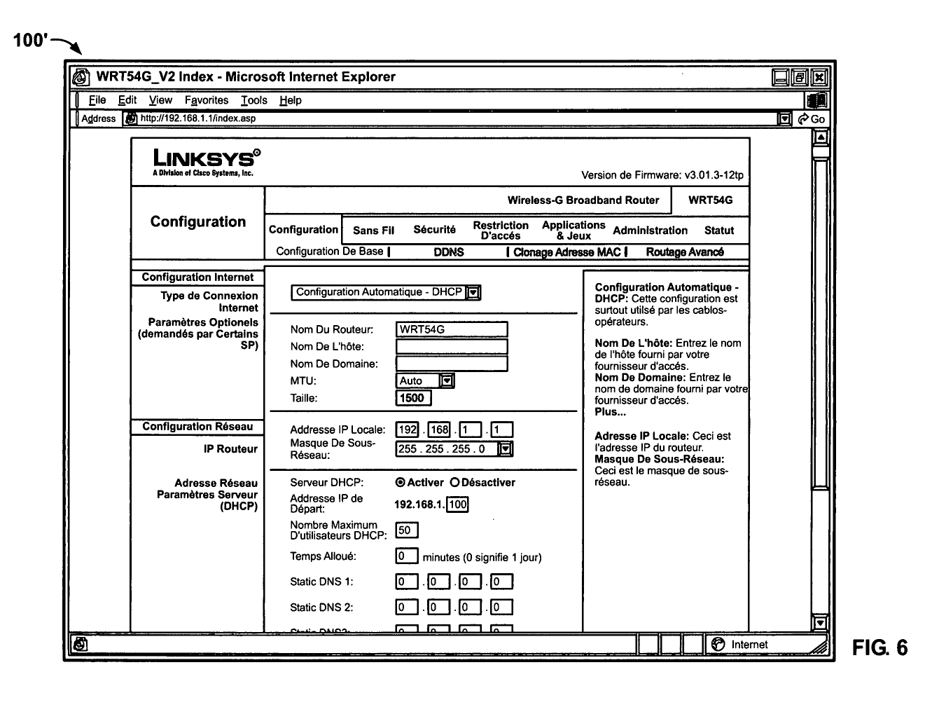

In step 409, the HTML data, including the translated text strings, is transmitted from the filter 240 to the browser application 230. In step 410, the browser application displays the management console interface with the translated text. FIG. 6 shows an exemplary localized management console interface 100′ translated from the management console interface 100 of FIG. 1.

In the embodiment described with respect to FIGS. 1-5, the markup language data from the embedded device is translated from one language to another. In accordance with other embodiments of the present invention, the markup language data from the embedded device is modified in other ways prior to display by the browser application.

For example, the filter 240 may include a customization setting identifying a service provider associated with the router 210. The filter 240 may then modify the content contained in the HTML data such that the management console interface is customized for that service provider. One modification that may be performed by the filter 240 is to replace the hardware manufacturer logo (e.g., the “Linksys” logo in the upper left hand corner of the interface 100 in FIG. 1) with the logo of the service provider. This could be accomplished by replacing the text string corresponding to the name of the hardware manufacturer with a text string corresponding to the name of the service provider. Alternatively, an image file containing the hardware manufacturer logo may be replaced with an image file containing the service provider logo. The replacement image file may be provided with the translation file and the filter DLL during the initial setup process. The background colors may also be modified to reflect colors associated with the service provider rather than the hardware manufacturer. Alternatively, the layout of the web page may be modified. As with the language translation embodiment described above, an advantage of this system is that the modifications to the HTML data to customize the interface for the service provider can be accomplished using the filter alone, without modifying the firmware for the router.

In other embodiments, the modifications to the markup language data can be used to localize the interface in other ways. For example, the first “language” provided by the embedded system may be standard English as used in the United States, and the filter may “translate” this first “language” into standard English as used in the United Kingdom. Thus, the filter may be used to localize the interface to accommodate regional dialects and other local preferences.

In yet other embodiments, the original text strings being modified need not be a human language. Instead, the text string may comprise a code. For example, the markup language data may include 16-bit codes instead of words. The filter may then be used to look up the code in a translation file and retrieve the corresponding language associated with that code. A disadvantage of this arrangement is that if the markup language data is accessed by a computer not provided with the filter for replacing the codes with words, the codes rather than words would be displayed by the browser, resulting in an incomprehensible interface.

Embodiments of the present invention may provide various advantages not provided by prior art systems. In particular, because the translation file is associated with a single embedded device or a limited class of embedded devices, the number of vocabulary terms included in the management console interface is limited. Thus, the translation file does not need to include a comprehensive dictionary of terms, and can be stored and accessed with a minimal amount of memory.

In addition, because the translation file may be provided in a file (such as a simple text file or table) separate from the markup language code in the embedded device, the addition of a newly supported language can be provided by merely adding the translated terms into a new column of the file. Thus, the router's firmware or other software does not need to be reprogrammed, saving the labor cost of the reprogramming and associated retesting each time a language is added.

While the invention has been described in terms of particular embodiments and illustrative figures, those of ordinary skill in the art will recognize that the invention is not limited to the embodiments or figures described. For example, the embedded device need not be limited to a router, access point, or other gateway device. Other types of embedded devices which provide content to be displayed by a browser application in a client device may be interfaced in this way. In addition, the format of the content may vary. For example, data containing JavaScript or Active Server Pages (ASP) code may be similarly filtered.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method of interfacing with an embedded system using a markup language, comprising:
retrieving markup language data from an embedded system;
detecting that the markup language data corresponds to a management console interface for the embedded system; and
modifying the markup language data for display by a browser application based on a customization setting.

2. The method of claim 1, wherein:
said customization setting comprises a preferred display language; and
said modifying the markup language data for display by the browser application comprises translating at least a portion of the markup language data from a first language into the preferred display language.

3. The method of claim 2, wherein said translating at least the portion of the markup language data to the second language comprises:
locating a character string from the markup language data in an entry in a translation table corresponding to the embedded system; and
retrieving a translated character string from the entry in the translation table.

4. The method of claim 1, wherein:
said embedded system comprises a gateway device.

5. The method of claim 4, wherein:
said gateway device comprises a router.

6. The method of claim 1, wherein:
said retrieving markup language data comprises retrieving markup language data stored in firmware of the embedded system.

7. The method of claim 1, wherein:
said detecting that said markup language data corresponds to the management console interface comprises detecting a predetermined embedded system identification string in the markup language data.

8. The method of claim 1, wherein:
said detecting that said markup language data corresponds to the management console interface and said translating at least the portion of the markup language data to the second language is performed by a pluggable Multipurpose Internet Mail Extensions (MIME) filter.

9. The method of claim 1, wherein:
said modifying the markup language data based on the customization setting comprises inserting replacing original content in the markup language data with modified content for display by the browser application.

10. The method of claim 9, wherein:
said original content comprises an original text string and said modified content comprises a replacement text string.

11. The method of claim 9, wherein:
said original content comprises an original image and said modified content comprises a replacement image.

12. The method of claim 9, wherein:
said original content comprises original program code and said modified content comprises replacement program code.

13. The method of claim 1, wherein:
said markup language comprises HyperText Markup Language (HTML).

14. A method of interfacing with an embedded system using a markup language, comprising:
accessing a management console interface for an embedded system using a browser application, said management console interface comprising text in a first language; and
translating at least a portion of the text of the management console interface into a second language.

15. The method of claim 14, wherein said translating at least the portion of the text into the second language comprises:
locating a character string from the markup language data in an entry in a translation table corresponding to the embedded system; and
retrieving a translated character string from the entry in the translation table.

16. The method of claim 14, wherein:
said embedded system comprises a gateway device.

17. A system for interfacing with an embedded system, comprising:
a filter for a browser application for retrieving and displaying markup language data, said filter being configured to detect that said markup language data corresponds to a management console interface for an embedded system, and, in response to that detection, replacing original content in the markup language data with replacement content.

18. The system of claim 17, wherein:
said filter is configured to replace original content in the markup language data with replacement content by replacing original text in a first language with translated text in a second language.

19. The system of claim 18, wherein said filter is configured to replace original text in the first language with the translated text in the second language by:
locating a character string from the original text in an entry in a translation table corresponding to the embedded system; and
retrieving a translated character string from the entry in the translation table.

20. The system of claim 17, wherein:
said embedded system comprises a gateway device.

21. The system of claim 17, wherein:
said filter is configured to detect that said markup language data corresponds to the management console interface by detecting a predetermined embedded system identification string in the markup language data.

22. The system of claim 17, wherein:
said filter comprises a pluggable Multipurpose Internet Mail Extensions (MIME) filter.

23. The system of claim 17, wherein:
said original content comprises an original text string and said replacement content comprises a replacement text string.

24. The system of claim 17, wherein:
said original content comprises an original image and said replacement content comprises a replacement image.

25. The system of claim 17, wherein:
said original content comprises original program code and said replacement content comprises replacement program code.

26. The system of claim 17, wherein:
said markup language comprises HyperText Markup Language (HTML).

27. A system for interfacing with an embedded system, comprising:
a means for retrieving and displaying markup language data;
a means for detecting that said markup language data corresponds to a management console interface for an embedded system in a first language; and
a means for translating at least a portion of the markup language data to a second language.
